(19) United States
(12) Patent Application Publication
(10) Pub. No.: US 2005/0058517 A1
(43) Pub. Date: Mar. 17, 2005

(54) Gear cutter with replaceable blades

(76) Inventor: Marian Dziag, Warszawa (PL)

Correspondence Address: Christopher W. Quinn, Esq.;Quinn Law Group, PLLC, Ste. 295, 38701 W. Seven Mile, Livonia, MI, 48152, US

(21) Appl. No.: 10/898,033

(22) Filed: Jul. 23, 2004

(30) Foreign Application Priority Data
Jul. 25, 2003 (PL) WP-3775

(51) Int. Cl. B23C 5/02

(52) U.S. Cl. 407/21

(57) ABSTRACT

The present invention provides a gear cutter for creating a bevel gear comprising a reusable cutter body surrounded by one or more reusable blades. The cutter body comprises a low grade machine steel, thereby significantly reducing costs. The removable blades comprise a high grade tool steel. Slots formed around the perimeter of the cutter body receive the blades, while openings drilled through the cutter body allow attachment with a gear cutting machine. When the blades are spent, they are removed from the cutter body and replaced with new blades. Reusing the cutter body in this manner significantly reduces waste and material costs.

### CROSS-REFERENCE TO RELATED APPLICATIONS

This application claims priority to Polish Application Wp-3775, filed on Jul. 25, 2003.

### TECHNICAL FIELD

The present invention relates to a gear cutting apparatus for creating a bevel gear, and more particularly to a gear cutting apparatus having removable and replaceable blades surrounding a cutting body.

### BACKGROUND OF THE INVENTION

Spiral bevel and hypoid gears are well known and widely used in a variety of industries. Conventionally, a spiral gear cutting machine employing a spiral bevel gear cutter produces teeth on a gear during production. Typical spiral bevel gear cutters comprise a plurality of blades permanently mounted into slots surrounding a circular cutter body. The blades may be welded or bored onto the cutter body, or they may be fused together using known heating techniques. Alternatively, the entire gear cutter can be formed as one piece. The blades themselves account for only approximately 3-5% of the total weight of the gear cutter. However, since the blades are integral with the cutter body, the entire gear cutter must be replaced when the blades are spent. Therefore, it is financially and ecologically desirable to provide a gear cutter having replaceable blades surrounding a reusable cutter body, thereby significantly reducing cost and waste materials.

Typically, spiral bevel gears comprise “tool steel”, defined as a grade of steel having high hardness and abrasion resistance. Tool steel is much more costly than lower grade steels, but must be used for the blades of the gear cutter in order to properly form the gear teeth. However, vast cost savings could be achieved by using a lower grade steel, or a “machine steel”, for a portion of the gear cutter. Therefore, it is desirable to provide a gear cutter having a cutter body comprising machine steel with blades comprising tool steel.

### SUMMARY OF THE INVENTION

Accordingly, the present invention provides a gear cutter for creating a bevel gear comprising a reusable cutter body surrounded by one or more reusable blades. The cutter body comprises a low grade machine steel, thereby significantly reducing costs. The removable blades comprise a high grade tool steel. Slots formed around the perimeter of the cutter body receive the blades, while openings drilled through the cutter body allow attachment with a gear cutting machine. When the blades are spent, they are removed from the cutter body and replaced with new blades. Reusing the cutter body in this manner significantly reduces waste and material costs.

### BRIEF DESCRIPTION OF THE DRAWINGS

The above features and advantages and other features and advantages of the present invention are readily apparent from the following detailed description of the best modes for carrying out the invention when taken in connection with the accompanying drawings, wherein:

FIG. 1 is a perspective view of a gear cutter according to the present invention;

FIG. 2 is an overhead view of the gear cutter of FIG. 1; and

FIG. 3 is a cross-sectional view of the gear cutter of FIG. 1.

### DESCRIPTION OF THE PREFERRED EMBODIMENTS

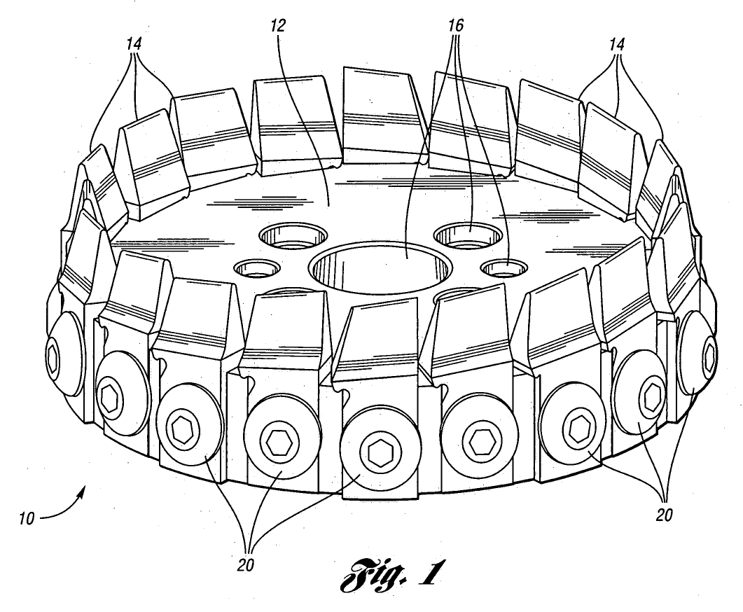

Referring to the drawings, FIG. 1 illustrates a gear cutter 10 according to the present invention. In the preferred embodiment, the gear cutter 10 has a diameter range of 2.75″ to 6″. The gear cutter 10 comprises a cutter body 12 having a plurality of blades 14 surrounding the perimeter. The preferred embodiment employs 16-20 blades 14; however, the cutter body 12 may be configured for any number of blades 14. The cutter body 12 comprises a low grade machine steel to reduce the overall cost of the gear cutter 10. The blades 14 comprise tool steel, preferably a high speed powdered material (PM) steel, thereby allowing proper functioning of the gear cutter 10.

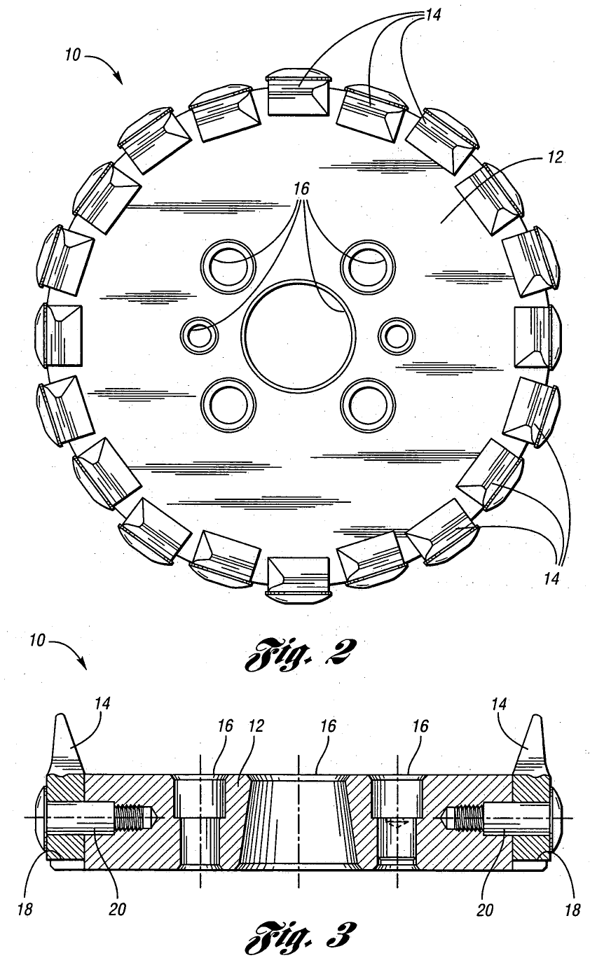

As best seen in FIG. 2, a plurality of mounting holes 16 are drilled through the cutter body 12 for mounting and dismounting the gear cutter 10 onto a spiral gear cutting machine. Slots 18 are provided around the outside perimeter of the cutter body 12 for receiving the blades 14. Preferably, press bolts 20 removably mount the blades 14 into the slots 18 on the cutter body 12. However, any removable mounting method which fixes the blades 14 in position may be used. Following blade 14 mounting, the blades 14 are sharpened, readying the gear cutter 10 for use.

When the blades 14 become dull from use, removal of the gear cutter 10 from the gear cutting machine facilitates re-sharpening of the blades 14. The blades 14 may be sharpened approximately 20 times before requiring replacement. Once the blades are spent, they are removed from the cutter body 12 by removing the press bolts 20. Since the blades 14 comprise approximately 8% of the total weight of the gear cutter 10, replacement of only the blades 14 significantly reduces the amount of waste material. On average, a cutter body 12 may be used for 10-20 sets of blades.

While the best modes for carrying out the invention have been described in detail, it is to be understood that the terminology used is intended to be in the nature of words and description rather than of limitation. Those familiar with the art to which this invention relates will recognize that many modifications of the present invention are possible in light of the above teachings. It is, therefore, to be understood that within the scope of the appended claims, the invention may be practiced in a substantially equivalent way other than as specifically described herein.

1. A gear cutter for creating a bevel gear, said gear cutter comprising:
a reusable cutter body comprising a low grade machine steel and adaptable to attach to a gear cutting machine for production of a gear; and
a blade for forming gear teeth, said blade comprising a high grade tool steel and removably attached to said cutter body.

2. The gear cutter of claim 1 wherein said cutter body includes a perimeter, and a slot formed within said perimeter receives said blade.

3. The gear cutter of claim 2 wherein said perimeter includes a plurality of slots and said gear cutter includes a plurality of blades, with one of said plurality of blades seated within each one of said plurality of slots.

4. The gear cutter of claim 1 wherein said blade detaches from said cutter body when said blade is spent to allow attachment of a new blade to said cutter body, thereby allowing reuse of said cutter body with said new blade.

5. The gear cutter of claim 1 wherein said cutter body includes at least one opening therethrough, said at least one opening adapted to receive a fastener for attaching said gear cutter to a gear cutting machine.

6. The gear cutter of claim 1 wherein said high grade tool steel comprises a PM steel.

7. The gear cutter of claim 1 further comprising a bolt for removably attaching said blade to said cutter body.

8. The gear cutter of claim 1 wherein said gear cutter is generally round with a diameter of 2.75″ to 6″.

9. A method of forming a gear cutter for creating a bevel gear comprising the steps of:
a) providing a reusable cutter body comprising low grade machine steel;
b) removably attaching at least one blade to said cutter body, said at least one blade comprising high grade tool steel;
c) sharpening said at least one blade while attached to said cutter body.

10. A method of reusing a cutter body of a gear cutter comprising the steps of:
a) providing a reusable cutter body formed of low grade machine steel;
b) removably attaching at least one blade to said cutter body, said at least one blade formed of high grade tool steel;
c) sharpening said at least one blade while attached to said cutter body;
d) re-sharpening said at least one blade while attached to said cutter body when said at least one blade becomes dull;
e) removing said at least one blade from said cutter body when re-sharpening will no longer produce a proper cut;
f) removably attaching at least one new blade to said cutter body, said at least one new blade comprising high grade tool steel; and
g) sharpening said at least one new blade while attached to said cutter body in preparation for reuse of said cutter body.
